(19) United States
(12) Patent Application Publication
(10) Pub. No.: US 2025/0358584 A1
(43) Pub. Date: Nov. 20, 2025

(54) LOCATION BASED AUDIO PROCESSING

(71) Applicant: Bang & Olufsen A/S, Struer (DK)

(72) Inventors: Oliver SCHEUREGGER, Valby (DK); Magnus Søgaard MAGNUSSEN, Taastrup (DK); Pablo MARTÍNEZ-NUEVO, Frederiksberg (DK); Sven Ewan SHEPSTONE, Struer (DK)

(21) Appl. No.: 19/174,840

(22) Filed: Apr. 9, 2025

(30) Foreign Application Priority Data
May 16, 2024 (EP) 24176417.4

(51) Int. Cl. H04S 7/00

(52) U.S. Cl. CPC H04S 7/303

(57) ABSTRACT

Techniques, computing devices, and systems for location based audio processing are described. An example technique includes determining, at a point in time, a location of a user within an environment including one or more audio reproduction devices. A set of audio processing parameters is determined based on the location of the user. The set of audio processing parameters is applied to at least one audio reproduction device of the one or more audio reproduction devices while audio content is output from the at least one audio reproduction device.

### CROSS-REFERENCE TO RELATED APPLICATION

This application claims priority to European Patent Application No. 24176417.4, filed May 16, 2024, which is incorporated by reference herein in its entirety.

### INTRODUCTION

### Field

The present disclosure generally relates to audio processing techniques, and more specifically but not exclusively, to techniques for performing audio processing based in part on a location of a user within an environment.

### BACKGROUND

In today's media-driven society, there are increasingly more ways for users to access video and audio content, with a plethora of devices reproducing sound in the home, car, outdoors, or almost any other environment. Portable devices reproducing audio, such as phones, tablets, laptops, headphones, portable loudspeakers, sound bars, and many other devices, are ubiquitous. The sounds reproduced by these devices may include, for example, a large variety of audio such as music, speech, podcasts, sound effects, and audio associated with video content. Additionally, portable devices are increasingly becoming more sophisticated with several features that allow a user to control the reproduction of audio. For example, many devices today may include features that allow users to control active noise cancellation (ANC) functionality, spatial audio (e.g., binaural audio) functionality, equalization (EQ), and head-tracking functionality, as illustrative, non-limiting examples.

As audio reproduction preferences may vary from user to user, the quality of a given user's audio experience may increase when users are allowed to customize their audio reproduction preferences. However, while the level of sophistication of today's devices may allow a user to have control over various technologies for listening to audio, the level of sophistication can become overwhelming and intrusive in many instances. For example, controlling the various functionality of a portable device may involve a user's frequent attention and a degree of technical competence to appropriately choose and/or find the user's desired and/or optimal settings in a given environment. Furthermore, to provide consistently optimal audio reproduction, many settings may involve adjustment based on the user's immediate environment (i.e., location). In this way, users today generally have to either adopt a one-size-fits-all approach or manually adjust settings as their immediate environment changes. Accordingly, it may be desirable to provide improved techniques for performing audio processing of one or more audio reproduction devices.

### SUMMARY

Particular aspects are set out in the appended independent claims. Various optional embodiments are set out in the dependent claims.

One embodiment described herein is a method performed by a computing device. The computer-implemented method includes determining, at a first point in time, a first location of a user within an environment comprising one or more audio reproduction devices. The computer-implemented method also includes determining a first set of audio processing parameters based on the first location of the user. The computer-implemented method further includes applying the first set of audio processing parameters to at least a first audio reproduction device of the one or more audio reproduction devices while audio content is output from the first audio reproduction device.

Another embodiment described herein is an audio reproduction device. The audio reproduction device includes one or more speaker components, one or more memories collectively storing instructions, and one or more processors coupled to the one or more memories and to the one or more speaker components. The one or more processors are collectively configured to execute the instructions to cause the audio reproduction device to perform an operation. The operation includes determining, at a point in time, a location of a user within an environment comprising the audio reproduction device. The operation also includes determining a set of audio processing parameters based on the location of the user. The operation further includes applying the set of audio processing parameters while outputting audio content from the one or more speaker components.

Another embodiment described herein is a computer-readable medium. The computer-readable medium includes computer executable code, which when collectively executed by one or more processors of an audio reproduction device causes the audio reproduction device to perform an operation. The operation includes determining, at a point in time, a location of a user within an environment comprising the audio reproduction device. The operation also includes determining a set of audio processing parameters based on the location of the user. The operation further includes applying the set of audio processing parameters while outputting audio content from the one or more speaker components.

Other embodiments provide: an apparatus operable, configured, or otherwise adapted to perform any one or more of the aforementioned methods and/or those described elsewhere herein; a computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

Various embodiments in accordance with the present disclosure will be described with reference to the drawings, where like designations denote like elements. Note that the appended drawings illustrate typical embodiments and are therefore not to be considered limiting; other equally effective embodiments are contemplated.

FIG. 1 illustrates an example system, according to one embodiment.

FIG. 2 illustrates an example computing environment, according to one embodiment.

FIG. 3 illustrates an example workflow for dynamically performing location-based audio processing, according to one embodiment.

FIG. 4 further illustrates certain components of the workflow illustrated in FIG. 3, according to one embodiment.

FIG. 5 further illustrates certain components of the workflow illustrated in FIG. 3, according to one embodiment.

FIG. 6 illustrates an example scenario for location-based audio processing based on a location zone, according to one embodiment.

FIG. 7 illustrates an example scenario for location-based audio processing based on multiple location zones, according to one embodiment.

FIG. 8 is a flowchart of a method for dynamically performing location-based audio processing, according to one embodiment.

### DETAILED DESCRIPTION

The present disclosure provides systems and techniques for performing audio processing based on a location of a user within an environment. More specifically, embodiments provide techniques for dynamically applying audio processing parameters to one or more audio reproduction devices based on the current location of the user within the environment.

In certain embodiments described herein, an adaptive audio component determines a set of audio processing parameters based on the user's location, and applies the set of audio processing parameters to one or more audio reproduction devices while audio is being output from the one or more audio reproduction devices. The audio reproduction devices may include wearable devices (e.g., headphones, earphones, earbuds, and similar devices), loudspeaker devices, and other computing devices capable of reproducing sound, such as phones, tablets, laptops, gaming consoles, and sound bars, as illustrative, non-limiting examples. The user's location may be determined using a variety of techniques, including, for example, using one or more sensors, one or more short-range wireless communication protocols, positioning systems, or any combination thereof. Using the techniques described herein, the audio processing parameters applied to the audio reproduction device(s) may dynamically change as the user's location changes within the environment. In this manner, embodiments herein allow for automatically adapting (e.g., without human intervention with the device) audio being output from one or more audio reproduction devices based in part on the user's real-time location, such that the auditory experience is modified in a way that is intuitive and expected by the user for the user's location.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

### Example System with Location-Based Audio Processing

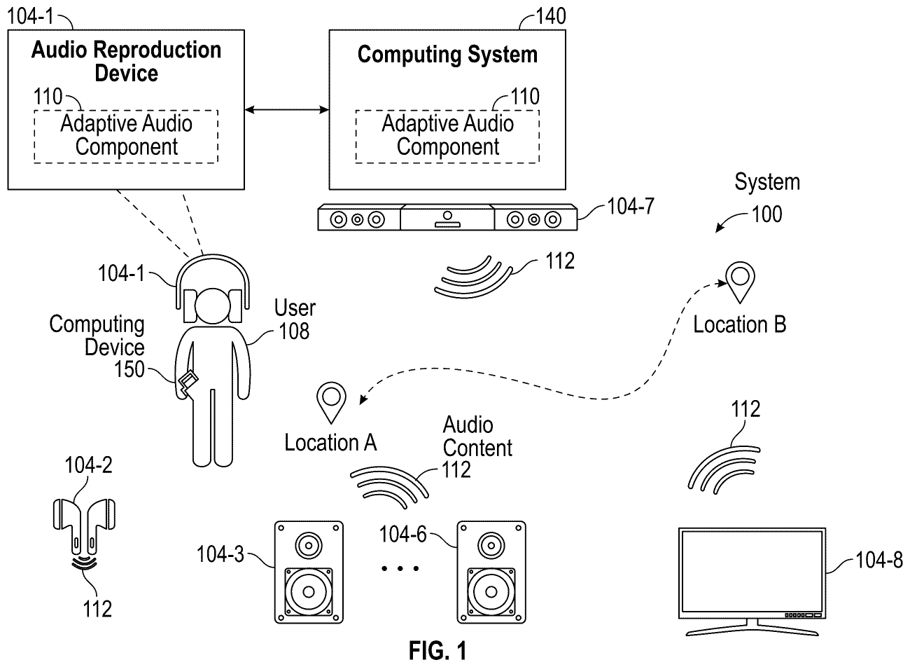

FIG. 1 illustrates an example location-based audio processing system 100 (hereinafter referred to as “system 100”), which is configured to implement one or more techniques described herein, according to one embodiment. The system 100 may be located in any environment, such as an indoor environment (e.g., home, vehicle, office, retail store, and other indoor environments), an outdoor environment (e.g., park, stadium, city sidewalk, and other outdoor environments), or other environment type (e.g., a blended indoor/outdoor environment, such as an outdoor kitchen and covered patio, as illustrative, non-limiting examples).

As shown, the system 100 includes a variety of audio reproduction devices 104-1 to 104-8 (collectively audio reproduction devices 104), a computing system 140, and a computing device 150. The computing system 140 is representative of a variety of computing systems, including, for example, a laptop computer, desktop computer, server, and similar computing devices. In one embodiment, the computing system 140 is located in a cloud computing environment. In such an embodiment, the computing system 140 may include a number of compute resources (e.g., processor(s), memory, and storage) distributed across one or more systems in the cloud computing environment.

The audio reproduction devices 104 are generally representative of any type of computing device capable of reproducing or outputting audio such as a loudspeaker and a wearable device, as illustrative, non-limiting examples. Loudspeakers are generally representative of any type of speakers, such as surround-sound speakers, satellite speakers, tower or floor-standing speakers, bookshelf speakers, sound bars, TV speakers, in-wall speakers, smart speakers, and portable speakers, as illustrative, non-limiting examples. In the example depicted in FIG. 1, the audio reproduction devices 104-3 to 104-8 include speakers (e.g., audio reproduction devices 104-3 to 104-6), a sound bar (e.g., audio reproduction device 104-7), and TV speakers (e.g., audio reproduction device 104-8). The loudspeakers may be installed in fixed positions or moveable. Additionally, the loudspeakers may include one or more speaker drivers, subwoofer drivers, woofer drivers, mid-range drivers, tweeter drivers, full range drivers, coaxial drivers, and amplifiers which may be mounted in a speaker enclosure. The loudspeakers may be communicatively coupled to the computing device 150, the computing system 140, and/or other audio reproduction devices 104 via a wireless or wired connection. That is, the loudspeakers may be wired or wireless. The loudspeakers are generally capable of converting an electrical audio signal into a corresponding sound. For example, each loudspeaker (e.g., audio reproduction devices 104-3 to 104-8) may include an electroacoustic transducer(s) for converting electrical audio signals into sound. One or more of the loudspeakers may also include a microphone for capturing audio signals from the environment in which the loudspeaker is located as well as other sensors described in greater detail herein.

Similarly, wearable devices are generally representative of a variety of wearable devices including earbuds, earphones, over-car headphones, on-ear headphones, closed-back headphones, and open-back headphones, as illustrative, non-limiting examples. In the example depicted in FIG. 1, the audio reproduction devices 104-1 to 104-2 include over-ear headphones (e.g., audio reproduction device 104-1) and earbuds (e.g., audio reproduction device 104-2). The wearable devices may be communicatively coupled to the computing device 150, the computing system 140, and/or other audio reproduction devices 104 via a wireless or wired connection. That is, the wearable devices may be wired or wireless. Wearable devices generally include two electroacoustic transducers (e.g., one transducer for the left car and another transducer for the right car) for converting electrical audio signals into sound. One or more of the wearable devices may also include at least one microphone for capturing audio signals from the environment in which the wearable device is located as well as other sensors described in greater detail herein.

It should be understood that while eight audio reproduction devices 104 are shown in FIG. 1, the system 100 may include fewer or greater number of audio reproduction devices 104. In certain embodiments, the audio reproduction devices 104 may be controlled via an input controller, such as the computing device 150 (e.g., smartphone or tablet). For example, the computing device 150 may receive user input and may provide corresponding control signals to the audio reproduction devices 104 to control various settings/functions/parameters, such as volume, communication settings, listening mode (e.g., ANC mode, transparency mode, and passive listening mode) and other suitable settings. In some systems, the audio reproduction devices 104 may have integrated input controllers. For example, at least one audio reproduction device 104 may have an integrated computing device (e.g., computing device 150) that can receive user input and provide corresponding control signals to control various settings/functions/parameters. In some systems, the input controller may be a separate device, such as a set top box (e.g., an audio/video receiver device). In some systems, the input controller may be distributed among one or more of the audio reproduction devices 104. For example, one of the audio reproduction devices 104 may be used as an input controller to control various settings/functions/parameters for one or more other audio reproduction devices 104. While a single computing device 150 is shown in FIG. 1, the system 100 may include any number of computing devices 150, any one of which may be used as an input controller.

In certain embodiments, one or more of the audio reproduction devices 104 includes an adaptive audio component 110. Additionally or alternatively, in certain embodiments, the computing system 140 includes an adaptive audio component 110. In certain embodiments, the adaptive audio component 110 may be distributed among one or more of the audio reproduction devices 104, computing system 140, and/or computing device 150. As described in greater detail below, the adaptive audio component 110 is configured to implement one or more techniques described herein for dynamically performing location-based audio processing for one or more of the audio reproduction devices 104.

Consider the scenario in FIG. 1, which depicts a user 108 interacting with the system 100, for example, by listening to audio content 112 output by one or more of the audio reproduction devices 104. In certain embodiments, the adaptive audio component 110 may determine the user's location within the environment and dynamically apply respective audio processing parameters to one or more of the audio reproduction devices 104 while the audio content 112 is being output from the audio reproduction devices 104. For example, assume that the user 108 is at “Location A” at a first instance in time and is listening to audio content 112 via audio reproduction device 104-1 (e.g., over-ear headphones). In this example, in response to determining the user 108 is at “Location A,” the adaptive audio component 110 may determine a set of audio processing parameters based on the user's location at “Location A” and may apply the set of audio processing parameters to the audio reproduction device 104-1 while the audio content 112 is being output from the audio reproduction device 104-1.

Continuing with the above example, further assume that the user 108 transitions within the environment from “Location A” to “Location B” and is at “Location B” at a second instance in time, subsequent to the first instance in time, listening to the audio content 112 via audio reproduction device 104-1. At this point, in response to determining the user 108 is at “Location B,” the adaptive audio component 110 may determine a different set of audio processing parameters based on the user's location at “Location B” and may apply the different set of audio processing parameters to the audio reproduction device 104-1 while the audio content 112 is being output from the audio reproduction device 104-1. The audio processing parameters may be associated with a type of the audio reproduction device 104 (e.g., the audio reproduction devices may support different technology or have different functionality/features), associated with the particular location (e.g., ANC may be enabled at locations associated with high amounts of ambient noise and may be disabled at locations associated with lower amounts of ambient noise), or any combination thereof. Example audio processing parameters may include, but are not limited to, listening mode parameter(s) (including ANC parameter(s), transparency parameters, and passive listening parameter(s)), head-tracking parameter(s), spatial audio parameter(s), volume parameter(s), and other audio processing parameters.

The adaptive audio component 110 may determine the user's location using a variety of techniques. In certain embodiments, for example, the adaptive audio component 110 may determine the user's location via the computing device 150 associated with the user 108. For example, the adaptive audio component 110 may consider the location of the computing device 150 as indicative of the user's location within the environment. In such cases, the user's location may be relative to the computing device's location. In another example, assuming the audio reproduction device 104 is collocated with the user (e.g., the user is wearing a wearable device, such as audio reproduction device 104-1), the adaptive audio component 110 may determine the user's location via the audio reproduction device 104. For example, the adaptive audio component 110 may consider the location of the audio reproduction device 104 as indicative of the user's location with the environment.

The adaptive audio component 110 may determine the location of the computing device 150 and/or audio reproduction device 104 (e.g., wearable device) using one or more location sensors of the computing device 150 and/or audio reproduction device 104. Such location sensors may include accelerometers, gyroscopes, magnetometers, an inertial measurement unit (IMU), and global positioning system (GPS) sensor(s), stereo cameras, light detection and ranging (LiDAR), and millimeter wave (mmWave) radar, as illustrative, non-limiting examples. In addition to or, as an alternative to, location sensor(s), the adaptive audio component 110 may determine the location of the computing device 150 and/or audio reproduction device 104 using one or more communication protocols, including short-range communication protocols, such as WiFi (e.g., 802.11 specifications), Bluetooth (e.g., Bluetooth Low Energy (BLE)), and ultra wideband (UWB), as illustrative, non-limiting examples. For example, the computing device 150 and/or audio reproduction device 104 may support positioning functionality using such communication protocols along with associated hardware (e.g., BLE tags, UWB tags, WiFi positioning system).

In certain embodiments, the set of audio processing parameters determined by the adaptive audio component 110 may be a predefined set of audio processing parameters associated with a given user's location. In one particular embodiment, the adaptive audio component 110 may determine the set of audio processing parameters based on the user's location relative to one or more predefined location zones in the environment. For example, one or more location zones may be defined within the environment, where each location zone is associated with a respective set of audio processing parameters (e.g., ANC parameter(s), head-tracking parameter(s), spatial audio parameter(s), volume parameter(s), bass level, and other audio processing parameters). In some examples, when the adaptive audio component 110 determines that the user is located within a particular location zone, the adaptive audio component 110 may automatically apply the respective audio processing parameters associated with that location zone while audio is output from the audio reproduction device(s) 104. In other examples, when the adaptive audio component 110 determines that the user is located outside a particular location zone (e.g., outside a single predefined location zone or between one or more predefined location zones), the adaptive audio component 110 may automatically apply the respective audio processing parameters associated with locations outside that location zone. In yet other examples described herein, when the adaptive audio component 110 determines that the user is between two or more predefined location zones, the adaptive audio component 110 may derive the respective audio processing parameters associated with the user's location from an interpolation of the audio processing parameters from the location zones nearest to the user's location. For example, if the user is located halfway between two location zones, then the adaptive audio component 110 may use a linear interpolation of the respective audio processing parameters in each location zone to provide an intermediate value of the audio processing parameters whose magnitude is proportional to the distance of the user between the two location zones. Note, however, that the adaptive audio component 110 can derive the respective audio processing parameters using other estimation techniques, such as linear extrapolation, trilinear interpolation, and linear regression, as illustrative, non-limiting examples.

In certain embodiments, the set of audio processing parameters may be dynamically generated using a machine learning (ML) model, a rules engine, or a combination thereof. In one particular embodiment, the adaptive audio component 110 may generate the set of audio processing parameters for a given user's location, based on evaluating metadata associated with the user's location with a ML model, a rules engine, or a combination thereof. In another embodiment, the adaptive audio component 110 may interact with another computing system (e.g., computing system 140) to obtain the set of audio processing parameters. For example, the adaptive audio component 110 may transmit a request (including metadata associated with the user's location) to the other computing system for the set of audio processing parameters, and receive a response (including the set of audio processing parameters) from the other computing system.

Referring again to FIG. 1, in certain embodiments, after a set of audio processing parameters associated with the user's location has been applied to one or more audio reproduction devices 104, the adaptive audio component 110 may obtain feedback from the user 108 regarding the applied set of audio processing parameters. For example, the user 108 may use an input controller (e.g., computing device 150, such as a smartphone or tablet) to provide feedback on the user's audio experience (e.g., indicating a user sentiment regarding the audio content 112, feedback on a particular audio processing parameter, such as volume or ANC setting, and other similar feedback). The adaptive audio component 110 may modify the set of audio processing parameters based on the user's feedback, and apply the modified set of audio processing parameters to the audio reproduction device(s) 104 as audio is output from the audio reproduction device(s) 104. In certain embodiments, the modified set of audio processing parameters may be determined using ML techniques. In some examples, the adaptive audio component 110 may use a ML model to evaluate the user's feedback and generate the modified set of audio processing parameters. In other examples, the adaptive audio component 110 may send the user's feedback to another computing system (e.g., computing system 140) that evaluates the user's feedback with a ML model, and may obtain the modified set of audio processing parameters from the other computing system.

Continuing with the above example described with respect to FIG. 1, the adaptive audio component 110 may continually adapt the audio processing parameters being applied to one or more of the audio reproduction devices 104 over time as the user's location changes within the environment. For example, assume the user 108 transitions within the environment from “Location B” to “Location A” and is listening to the audio content 112 via audio reproduction device 104-1 at “Location A” at a third instance in time, subsequent to the second instance in time. At this point, the adaptive audio component 110 may (re) apply the set of audio processing parameters associated with “Location A” to the audio reproduction device 104-1 as the audio content 112 is output from the audio reproduction device 104-1.

Note that while FIG. 1 depicts the adaptive audio component 110 being implemented on an audio reproduction device 104 and/or a computing system 140, in other embodiments, the adaptive audio component 110 may be implemented on another device, such as the computing device 150. Additionally, note that while the above example described with respect to FIG. 1 assumes the user 108 listens to the same audio content (e.g., audio content 112) as the user's location changes over time within the environment, in certain embodiments, the audio content that is being output by one or more of the audio reproduction devices 104 may be different at different locations within the environment. That is, in some embodiments, the set of audio processing parameters may include audio content.

Further, note that while the above example assumes that the user 108 is listening to the audio content 112 via the same audio reproduction device (e.g., audio reproduction device 104-1) as the user's location changes, other various scenarios are contemplated. For example, in some cases, the user 108 may listen to audio content 112 using audio reproduction device 104-1 at “Location A” and may listen to audio content 112 using another one of, or combination of, the audio reproduction devices 104-2 to 104-8. In yet another example, the user 108 may listen to audio content 112 using any first set of the audio reproduction devices 104-1 to 104-8 at “Location A” and may listen to audio content 112 using any second set of the audio reproduction devices 104-1 to 104-8 at “Location B.”

Advantageously, the adaptive audio component 110 described herein may automatically adapt audio being output from one or more audio reproduction devices 104 based in part on the user's real-time location, such that the auditory experience is modified in a way that is intuitive and expected by the user for the user's location.

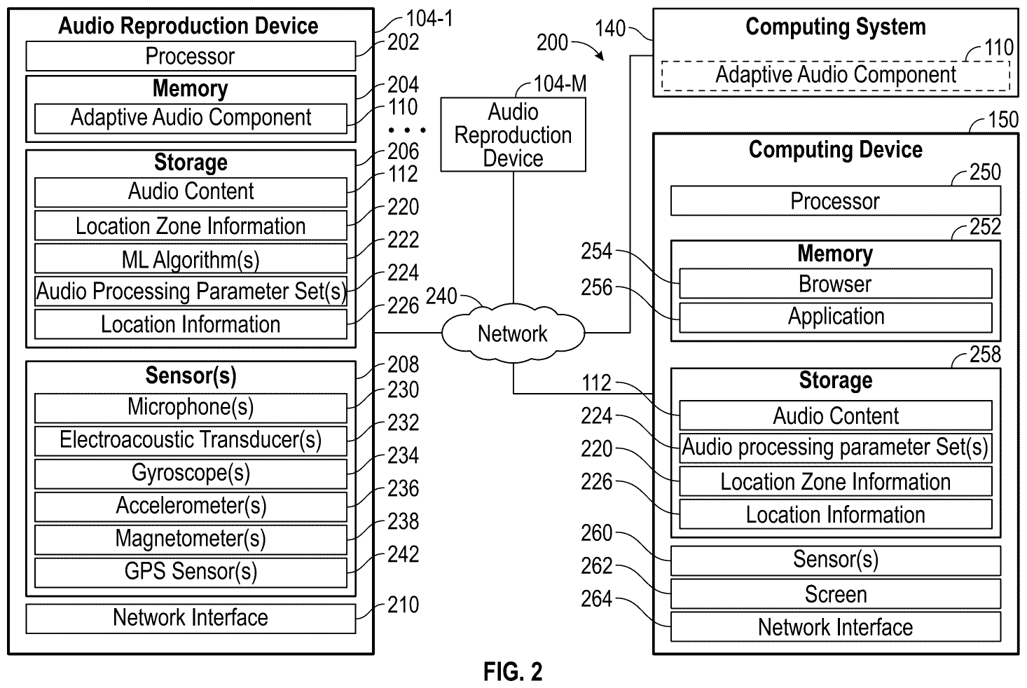

FIG. 2 illustrates an example of a computing environment 200 used to perform location-based audio processing, according to one embodiment. As shown, the computing environment 200 includes one or more audio reproduction devices 104 1-M, computing system 140, and the computing device 150, which are interconnected via a network 240.

The network 240, in general, may be a wide area network (WAN), a local area network (LAN), a wireless LAN, a personal area network (PAN), a cellular network, a wired network, or other suitable network types. In a particular embodiment, the network 240 is the Internet. Wireless connections between components of the computing environment 200 may be provided via a short-range wireless communication technology, such as Bluetooth, WiFi, ZigBee, UWB, or infrared, as illustrative, non-limiting examples. Wired connections between components of the computing environment 200 may be via auxiliary audio cable, universal serial bus (USB), high-definition multimedia interface (HDMI), video graphics array (VGA), or any other suitable wired connection.

As shown, each audio reproduction device 104 includes a processor 202, a memory 204, a storage 206, one or more sensors 208, and a network interface 210. The processor 202 represents any number of processing elements, which can include any number of processing cores. The memory 204 can include volatile memory, non-volatile memory, and combinations thereof. The memory 204 generally includes program code for performing various functions for dynamically performing location-based audio processing. The program code is generally described as various functional “components” or “modules” within the memory 204, although alternate implementations may have different functions or combinations of functions. Here, the memory 204 includes an adaptive audio component 110 (e.g., software component or logic), which is described in greater detail herein.

The storage 206 may be a disk drive storage device. Although shown as a single unit, the storage 206 may be a combination of fixed and/or removable storage devices, such as fixed disc drives, removable memory cards, optical storage, network attached storage (NAS), or a storage area network (SAN). Here, the storage 206 includes audio content 112, location zone information 220, ML algorithm(s)/model(s) 222, audio processing parameter set(s) 224, and location information 226, which are described in greater detail herein.

The sensor(s) 208 generally includes one or more sensors that are configured to sense information from the physical environment. Here, the sensor(s) 208 includes one or more microphones 230, one or more electroacoustic transducers 232, one or more gyroscopes 234, one or more accelerometers 236, one or more magnetometers 238, and one or more GPS sensors 242. The microphone(s) 230 is generally a transducer that converts sound into an electrical signal(s). Here, for example, the microphone(s) 230 can capture external sound, convert the external sound into electrical signals, and provide the electrical signals to the adaptive audio component 110 for processing. The electroacoustic transducer(s) 232 convert electrical signals to acoustic signals. For example, an electroacoustic transducer 232 may receive an electrical signal(s) from the adaptive audio component 110 and/or the computing device 150 (via network interface 210), may convert the electrical signal(s) into acoustic signals, and may output or provide the acoustic signals to a listener.

The gyroscope(s) 234 measures orientation of the audio reproduction device 104, and provides information as to whether the audio reproduction device 104 is titled in one or more planes. The accelerometer(s) 236 measures acceleration forces acting on the audio reproduction device 104 and may provide information as to whether the audio reproduction device 104 is moving, and in which direction(s). The magnetometer(s) 238 measures the strength and direction of a magnetic field surrounding the audio reproduction device 104. The GPS sensor(s) 242 can obtain position, velocity, and timing information from a satellite-based navigation system and/or one or more computing devices, such as a smartphone. In certain embodiments, the accelerometer(s) 236, gyroscope(s) 234, and/or magnetometer(s) 238 arc included within an IMU of the audio reproduction device 104. In one embodiment, the combination of the accelerometer(s) 236, gyroscope(s) 234, magnetometer(s) 238 and/or GPS sensor(s) 242 may provide information of a position as well as direction sense for the audio reproduction device 104 in terms of pitch, roll, and yaw with respect to gravity. For example, certain audio reproduction devices 104 (e.g., wearable devices) that support head-tracking may utilize information from the GPS sensor(s) 242 to determine a user's geographical location and utilize information from the accelerometer(s) 236, gyroscope(s) 234, and/or magnetometer(s) 238 to determine a user's head orientation information in three dimensions (3D) and dynamically update a spatial audio rendering algorithm based on the head orientation information.

The network interface 210 may be any type of network communications interface (e.g., WiFi, Bluetooth, UWB, etc.) that allows the audio reproduction device 104 to communicate with other computers and/or components in the computing environment 200 via a data communications network (e.g., network 240). In certain embodiments described in greater detail herein, one or more communication signals may be used to determine a location of the audio reproduction device 104. For example, the audio reproduction device 104 may include positioning functionality using short-range communication protocols, such as WiFi, Bluetooth (e.g., BLE), and UWB, as illustrative examples.

Computing device 150 is generally representative of a mobile or handheld computing device, including, for example, a smartphone, a tablet, a laptop computer, etc. Here, the computing device 150 includes a processor 250, a memory 252, a storage 258, one or more sensors 260, a screen 262, and a network interface 264. The processor 250 represents any number of processing elements, which can include any number of processing cores. The memory 252 can include volatile memory, non-volatile memory, and combinations thereof.

The memory 252 generally includes program code for performing various functions related to applications (e.g., application 256, browser 254) hosted on the computing device 150. The program code is generally described as various functional “applications” or “modules” within the memory 252, although alternate implementations may have different functions or combinations of functions. Here, the memory 252 includes a browser 254 and an application 256. The application 256 and/or browser 254 may be used for a variety of functions, including, for example, accessing audio content (e.g., audio content 112), accessing computing system 140 (including adaptive audio component 110), playing audio content, accessing/controlling settings of the audio reproduction device(s) 104, and other suitable functions.

In particular, the browser 254 may be used to access the computing system 140 by rendering web pages received from the computing system 140. The application 256 may be representative of a component of a client server application or other distributed application which can communicate with the computing system 140 over the network 240. Application 256 may be a “thin” client where the processing is largely directed by the application 256, but performed by computing systems, or a conventional software application installed on the computing device 150.

The storage 258 may be a disk drive storage device. Although shown as a single unit, the storage 258 may be combination of fixed and/or removable storage devices, such as fixed disc drives, removable memory cards, optical storage, NAS, or a SAN. Here, the storage 258 includes audio content 112, audio processing parameter set(s) 224, location zone information 220, and location information 226, which are described in greater detail herein. The sensor(s) 260 may be similar to the sensor(s) 208 of the audio reproduction device 104. For example, the sensor(s) 260 may include a microphone(s), electroacoustic transducer(s), gyroscope(s), accelerometer(s), magnetometer(s), GPS sensor(s), and other suitable sensors.

The screen 262 may include a Liquid Crystal Display (LCD), a Light Emitting Diode (LED), or other display technology. In one embodiment, the screen 262 includes a touch-screen interface. The network interface 264 may be any type of network communications interface that allows the computing device 150 to communicate with other computers and/or components in the computing environment 200 via a data communications network (e.g., network 240).

Note that FIG. 2 illustrates a reference example of a computing environment 200 in which the techniques presented herein can be implemented and that the techniques presented herein can be implemented in other computing environments.

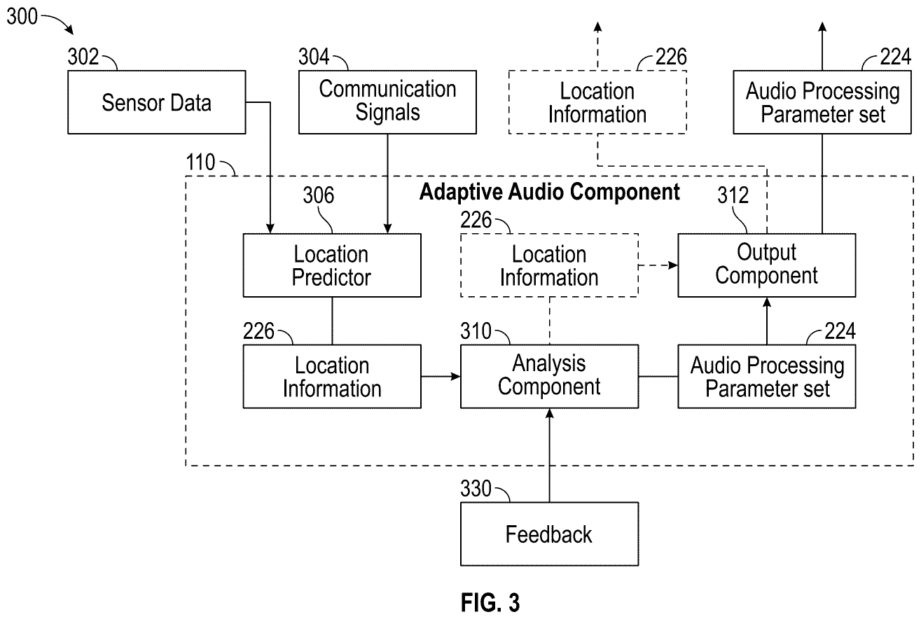

FIG. 3 illustrates an example workflow 300 for dynamically performing location-based audio processing, according to one embodiment. As shown, the adaptive audio component 110 may include a location predictor 306, an analysis component 310, and an output component 312. In the workflow 300, the location predictor 306 is configured to predict (or, more generally, determine) a location of a user (e.g., user 108) within an environment.

The location predictor 306 may use a variety of techniques for predicting the user's location. In certain embodiments, the location predictor 306 may obtain sensor data 302 (e.g., IMU data, GPS sensor data, or a combination thereof) from a computing device associated with the user (e.g., data from sensor(s) 260 of computing device 150) and/or from an audio reproduction device collocated with the user (e.g., data from sensor(s) 208 of audio reproduction device 104-1). In some cases, the sensor data 302 may include an indication of a location of the computing device and/or the collocated audio reproduction device. In such cases, the location predictor 306 may consider the location of the computing device and/or the collocated audio reproduction device as the user's location at a particular point in time.

In certain embodiments, the location predictor 306 may obtain one or more communication signals 304 from one or more computing devices and/or computing systems, and predict the user's location based on the one or more communication signals 304. In some cases, the communication signals 304 may be short-range wireless communication signals associated with short-range wireless communication protocols, such as WiFi, BLE, and UWB, as illustrative, non-limiting examples. In some cases, the communication signals 304 may be from a positioning system (e.g., WiFi positing system). The location predictor 306 may perform positioning based on the communication signals 304, e.g., using any suitable positioning-based methods, such as two way ranging (TWR) and time difference of arrival (TDoA), as illustrative, non-limiting examples. Based on the sensor data 302, communication signals 304, or a combination thereof, the location predictor 306 may provide location information 226 (including an indication of the user's location) to the analysis component 310.

The analysis component 310 is generally configured to determine a set of audio processing parameters 224, based on the location information 226 (including an indication of the user's location) and/or feedback 330 (if available). The feedback 330 may include user feedback regarding the user's audio experience. For example, the feedback 330 may indicate a user sentiment regarding the audio content 112, indicate feedback on a particular audio processing parameter, and other similar feedback.

As described in greater detail below, in certain embodiments, the analysis component 310 may determine the set of audio processing parameters 224, based on selecting a predefined set of audio processing parameters associated with the user's location (within the location information 226). As also described in greater detail below, in other embodiments, the analysis component 310 may determine the set of audio processing parameters 224, based on evaluating the location information 226 and/or feedback 330 with a ML model (e.g., ML algorithm(s) 222), rules engine, or a combination thereof. The analysis component may provide the set of audio processing parameters 224 to the output component 312.

The output component 312 is generally configured to automatically apply the set of audio processing parameters 224 to the audio reproduction device(s) (e.g., audio reproduction device(s) 104) to modify the playback of the audio content from the audio reproduction device(s). In some cases, the output component 312 may send the set of audio processing parameters 224 to the audio reproduction device(s) in order for the audio reproduction device(s) to apply to the playback of audio content.

Note, in certain embodiments, the analysis component 310 may be configured to generate and send a request for another computing system to determine the set of audio processing parameters 224. In the workflow 300, for example, the analysis component 310 may provide the location information 226 to the output component 312, which may generate a request (including the location information 226) and transmit the request to another computing system (e.g., computing system 140). Although not shown, the output component 312 may receive a response (including the set of audio processing parameters 224) from the other computing system. The other computing system may employ ML techniques, a rules engine, or a combination thereof to generate the set of audio processing parameters, based on the location information 226.

Note that FIG. 3 illustrates a reference example configuration of an adaptive audio component 110 and that the adaptive audio component 110 may have other configurations consistent with the functionality described herein. For example, while the adaptive audio component 110 is depicted with three components, in certain embodiments, the adaptive audio component 110 may be implemented with fewer or a greater number of components.

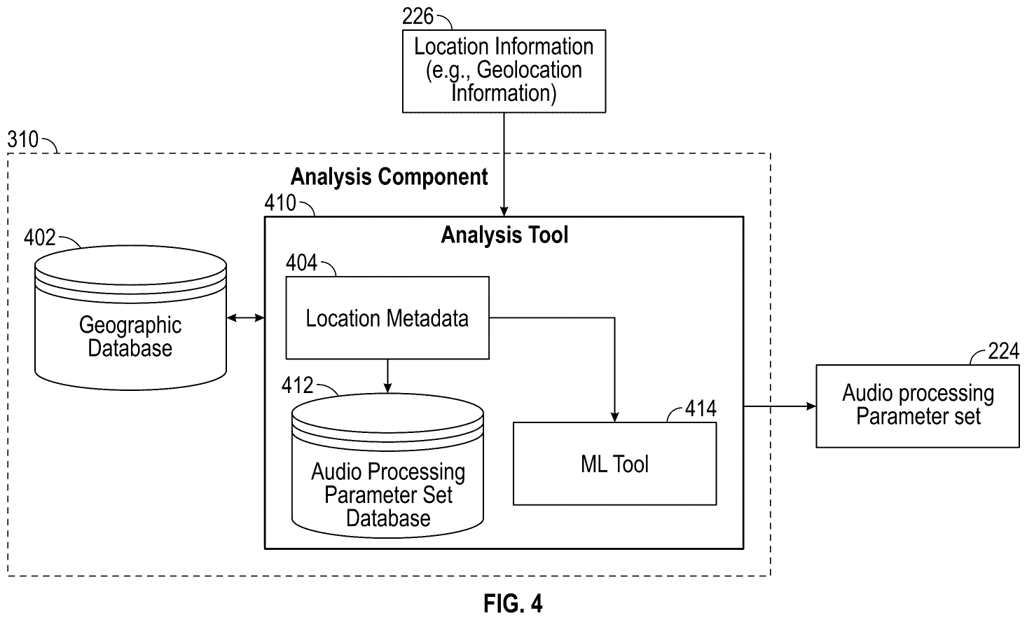

FIG. 4 further illustrates certain components of the analysis component 310 of the workflow 300, described relative to FIG. 3, according to one embodiment. As shown, in certain embodiments, the analysis component 310 may include a geographic database(s) 402 and an analysis tool 410. While FIG. 4 depicts the geographic database(s) 402 within the analysis component 310, note that the geographic database(s) 402 may be stored locally or remotely with respect to the adaptive audio component 110.

In the depicted embodiment, the analysis tool 410 may obtain location information 226 (e.g., from the location predictor 306), where the location information 226 includes geolocation information. For example, the geolocation information may include a geographical coordinate in a geographical coordinate system, such as a Cartesian coordinate system, polar coordinate system, and cylindrical coordinate system, as illustrative, non-liming examples. The analysis tool 410 may access the geographic database(s) 402 with the geolocation information to determine location metadata 404 associated with the user's location. For example, the geographic database(s) 402 may include geographical information, including one or more maps, geographical features, and other information. One reference and non-limiting example of a geographic database 402 is OpenStreetMap. The location metadata 404 obtained from the geographic database(s) 402 may include one or more attribute tags (e.g., metadata tags) associated with the location metadata 404. In one reference example, the location metadata 404 may include an “area” attribute tag indicating an area type of the user's location (e.g., Area=residential), a “name” attribute tag indicating a name of the user's location (e.g., Name=Park Avenue), and a maximum speed at the user's location (e.g., 50 miles per hour (mph)).

In certain embodiments, the analysis tool 410 may select a predetermined set of audio processing parameters, based on the location metadata 404, and use the selected predetermined set of audio processing parameters as the set of audio processing parameters 224. For example, the analysis tool 410 may access the database(s) 412 with the attribute tags from the location metadata 404 to determine which predefined set of audio processing parameters corresponds to the attribute tags. The database(s) 412, for example, may include multiple predefined sets of audio processing parameters corresponding to different location metadata. While FIG. 4 depicts the database(s) 412 within the analysis component 310, note that the database(s) 412 may be stored locally or remotely with respect to the adaptive audio component 110. Similarly, while FIG. 4 depicts the database(s) 412 being separate from the database(s) 402, in certain embodiments, the information within database(s) 412 and the information within database(s) 402 may be included within a single storage system.

In certain embodiments, the analysis tool 410 may evaluate the location metadata 404 with a ML tool 414 to generate the set of audio processing parameters 224. For example, the ML tool 414 may evaluate the attribute tags from the location metadata 404 using one or more ML algorithms/models 222 and/or a rules engine. The ML algorithms/models 222 may be trained to accept location metadata 404 (or, more generally, location information 226) as inputs and to output, in response, a set of audio processing parameters 224 that corresponds to the location metadata 404. For example, the ML algorithms/models 222 may be neural networks such as deep neural networks, and may be trained using supervised learning techniques based on labeled training data that includes a user preferences along with corresponding user locations. The rules engine may be configured to evaluate the location metadata 404 using one or more predefined rules, and output a set of audio processing parameters 224 that corresponds to the location metadata 404. Such rules may be predefined by the user or other sources, or generated via ML techniques.

By dynamically generating and applying a set of audio processing parameters 224 to an audio reproduction device 104, based on the user's current geographical location, embodiments herein can automatically modify the playback of audio from the audio reproduction device 104 to adapt to the surrounding context of the user's location and the user's preferences. For example, when the user is listening to audio content via a wearable device in a geographical area with a lot of traffic (e.g., city street), the adaptive audio component 110 can automatically and seamlessly determine to turn on the ANC listening mode on the wearable device and set a high level for the volume and/or a high level for the bass setting on the wearable device. In another example, when the user is listening to audio content via a wearable device in a park, the adaptive audio component 110 can automatically and seamlessly determine to turn on transparency listening mode on the wearable device and set a low level for the volume and/or a low level for the bass setting on the wearable device. The particular audio processing parameters that are applied at the user's particular location can be based on the user's preferred presets, dynamically generated (e.g., using a ML model or rules engine), or a combination thereof. In this manner, as the user's location changes within an environment, the adaptive audio component 110 can automatically adapt the audio playback, such that the auditory experience is modified in a way that is intuitive and expected by the user for the user's location.

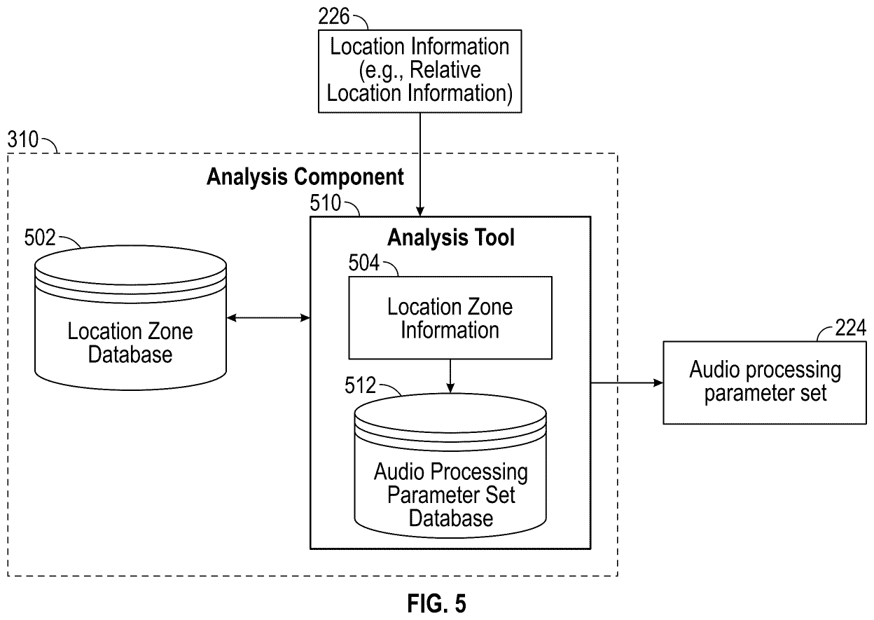

FIG. 5 further illustrates certain components of the analysis component 310 of the workflow 300, described relative to FIG. 3, according to one embodiment. As shown, in certain embodiments, the analysis component 310 may include a location zone database(s) 502 and an analysis tool 510. While FIG. 5 depicts the location zone database(s) 502 within the analysis component 310, note that the location zone database(s) 502 may be stored locally or remotely with respect to the adaptive audio component 110.

As shown in FIG. 5, the analysis tool 510 may obtain location information 226 (e.g., from the location predictor 306), where the location information 226 includes relative location information. That is, the user's location may be relative to the location of one or more computing devices or systems in the environment (e.g., laptop, phone, etc.). The analysis tool 510 may access the location zone database(s) 502 with the location information 226 to determine whether the user's location is within one of one or more predefined location zones in the environment. For example, the location zone database(s) 502 may include information regarding one or more predefined location zones in one or more environments. As described below, each location zone may be predefined by the user (e.g., user 108) via an input controller, such as computing device 150. For example, the user may define the respective area of each location zone by, e.g., setting a radius for the location zone, setting a width/length/height for the location zone, custom defining a shape of the location zone, setting a distance from the center of another location zone, or a combination thereof. It should be noted that while the above example uses a wearable device, the techniques described herein can be applied to other audio reproduction devices (e.g., loudspeaker).

In certain embodiments, the analysis tool 510 may select a predetermined set of audio processing parameters, based on the location zone information 504, and use the selected predetermined set of audio processing parameters as the set of audio processing parameters 224. For example, the analysis tool 510 may access the database(s) 512 with the location zone information 504 (including an indication of which location zone, if any, the user 108 is located in) to determine which predefined set of audio processing parameters corresponds to the location zone. The database(s) 512, for example, may include multiple predefined sets of audio processing parameters corresponding to different location zones. As described below, the respective sets of audio processing parameters for the location zones may be predefined by the user. While FIG. 5 depicts the database(s) 512 within the analysis component 310, note that the database(s) 512 may be stored locally or remotely with respect to the adaptive audio component 110. Similarly, while FIG. 5 depicts the database(s) 512 being separate from the database(s) 502, in certain embodiments, the information within database(s) 512 and the information within database(s) 502 may be included within a single storage system.

By dynamically generating and applying a set of audio processing parameters 224 to an audio reproduction device 104, based on the user's relative location with respect to one or more location zones, embodiments herein can automatically modify the playback of audio from the audio reproduction device 104 to adapt to the surrounding context of the user's location and the user's preferences. For example, the user may set up one or more listening zones in the user's office, where a first listening zone is set up around the user's desk and a second listening zone is set up around a communal area within the office. In this example, when the user is listening to audio content with a wearable device within the first listening zone (e.g., the user is at their desk), the adaptive audio component 110 may automatically (e.g., without user intervention) apply a predefined set of audio processing parameters (e.g., ANC mode=“ON”, Transparency mode=“OFF”) to the wearable device for the first listening zone. If the user changes locations and listens to audio content with the wearable device within the second listening zone (e.g., the user goes to the communal area in the office), the adaptive audio component 110 may automatically apply a predefined set of audio processing parameters (e.g., ANC mode=“OFF”, Transparency mode=“ON”) to the wearable device for the second listening zone. In this manner, the user's auditory experience can be dynamically and seamlessly modified in a way that is expected by the user for the user's location within the environment. It should be noted that while the above example uses a wearable device, the techniques described herein can be applied to other audio reproduction devices (e.g., loudspeaker).

Note that FIG. 4 and FIG. 5 illustrate reference examples of an analysis component 310 and that the analysis component 310 may have other configurations consistent with the functionality described herein. For example, in certain embodiments, the analysis component 310, described relative to FIG. 3, may include one or more components (e.g., geographic database(s) 402 and analysis tool 410) depicted in FIG. 4, one or more components (e.g., location zone database(s) 502 and analysis tool 510) depicted in FIG. 5, or any combination thereof.

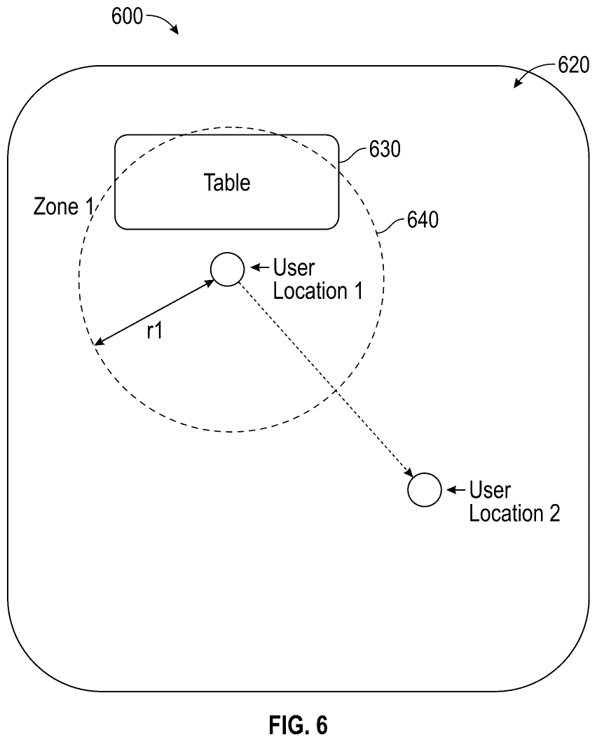

FIG. 6 illustrates an example scenario 600 for location-based audio processing based on a location zone within an environment 620, according to one embodiment. In the depicted scenario 600, a user (e.g., user 108) may define a location zone 640 within the environment 620. For example, when the user is at “User Location 1” (e.g., at a table 630 within the environment 620), the user may use an input controller (e.g., integrated input controller, computing device 150, etc.) to interact with the adaptive audio component (e.g., adaptive audio component 110) of an audio reproduction device (e.g., audio reproduction device 104) to define a new location zone. This location may be absolute (e.g., a specified coordinate within a known coordinate system), or relative (e.g., a vector that points away from the current position or computing device). For example, the user may indicate, via the input controller, that the user desires to set a new location zone. Note, in some cases, the audio reproduction device may be a wearable device (e.g., audio reproduction device 104-1 or 104-2) collocated with the user. In other cases, the audio reproduction device may be a loudspeaker (e.g., audio reproduction device 104-3) at the table 630.

In response to receiving the indication, the adaptive audio component 110 may predict the user's current location (e.g., “User Location 1”). As noted, the adaptive audio component 110 may use a variety of techniques to predict the user's current location based on, e.g., sensor data 302, communication signals 304, or any combination thereof. The predicted user's location may be relative to the location of another computing device (e.g., smartphone, laptop, or other peripheral device). Using the input controller, the user may define at least one of an area or contour of the location zone 640 (e.g., setting a radius, setting a width/length/height, custom defining a shape, or a combination thereof). Here, for example, the user may define a radius r1 from “User Location 1” for the location zone 640.

The user may also use the input controller to define a set of audio processing parameters that should apply to a defined set of audio reproduction devices when the user's location is within the location zone 640. As a reference non-limiting example, the user may specify that, for audio reproduction device 104-1, (i) ANC is ‘ON’ (and Transparency is ‘OFF’), (ii) spatial (e.g., binaural) rendering is ‘ON’, (iii) IMU (head-tracking) is ‘enabled’, (iv) default volume is 70%, and (v) low-power mode is ‘disabled’, when the user's location is within the location zone 640. In certain embodiments, the user may also define a different set of audio processing parameters that should apply to a defined set of audio reproduction devices when the user's location is outside of the location zone 640. As a reference non-limiting example, the user may specify that, for audio reproduction device 104-1, (i) Transparency is ‘ON’ (and ANC is ‘OFF’), (ii) spatial (e.g., binaural) rendering is ‘OFF’, (iii) IMU (head-tracking) is ‘disabled’, (iv) default volume is 30%, and (v) low-power mode is ‘enabled’ to save battery, when the user's location is outside of the location zone 640.

As the user moves within the environment 620, the adaptive audio component 110 may process the sensor data 302 and/or communication signals 304 to predict whether the user is within the location zone 640 or outside of the location zone 640. For example, after the user transitions from “User Location 1” to “User Location 2”, the adaptive audio component may automatically apply the set of audio processing parameters associated with locations external to the listening zone 640.

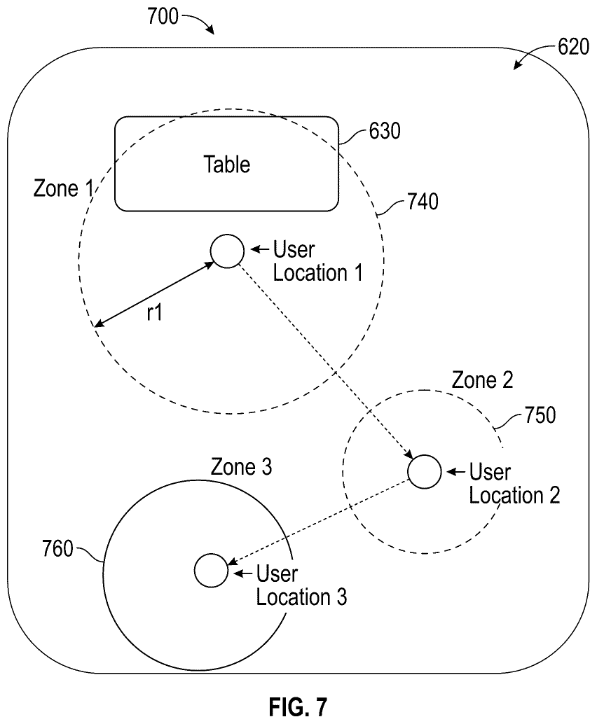

FIG. 7 illustrates another example scenario 700 for location-based audio processing based on multiple location zones within an environment 620, according to one embodiment. In the depicted scenario 700, the user (e.g., user 108) may use a variety of techniques to define the location zones 740, 750, and 760.

In certain embodiments, the user may physically move to a different location within the environment 620 to define a respective location zone at the different locations. For example, in the scenario 700, the user may start at “User Location 1” and define the location zone 740 and the set of audio processing parameters associated with location zone 740 (e.g., via an input controller). The user may then transition from “User Location 1” to “User Location 2” and define the location zone 750 and the set of audio processing parameters associated with location zone 750 (e.g., via an input controller). The user may then transition from “User Location 2” to “User Location 3” and define the location zone 760 and the set of audio processing parameters associated with location zone 760. The user may continue in this manner until a desired number of location zones has been predefined. Note, the user may define each location zone using any of the techniques described herein (e.g., setting a radius, setting a width/length/height, custom defining a shape, or a combination thereof).

In certain embodiments, the user may define the location zones 740, 750, and 760 while the user is at a single location (e.g., “User Location 1”). For example, in one embodiment, the user may provide, to the adaptive audio component 110, the respective distance and direction of each additional location zone (e.g., location zones 750 and 760) relative to the initial defined location zone (e.g., location zone 740). Note, in this embodiment, the adaptive audio component 110 may prompt the user to verify that the distance and direction information provided is feasible (e.g., the environment 620 can physically support the location zone(s) setup).

In another embodiment, the environment 620 may include multiple location sensors (e.g., UWB anchors/tags, BLE beacons, or other similar sensors) deployed in various locations within the environment 620. In this embodiment, the adaptive audio component 110 may use sensor data from the location sensors to render a map of the environment 620 and display the map to the user via a computing device associated with the user (e.g., computing device 150). The user can then define each location zone (e.g., location zones 740, 750, and 760) within the map and also provide the corresponding set of audio processing parameters for the respective location zone.

Note that while FIG. 7 depicts the location zones 740, 750, and 760 as non-overlapping, in certain embodiments, one or more of the location zones 740, 750, and 760 may be allowed to overlap. In such embodiments, the selection of which set of audio processing parameters to apply may be determined by a respective confidence level of the user being located within each location zone, a respective priority of each location zone, or a combination thereof. For example, assuming the confidence level of the user being in location zone 740 is 50%, the confidence level of the user being in location zone 750 is 60%, and the confidence level of the user being in location zone 760 is 90% (where one or more of the location zones 740, 750, and 760 overlap), the adaptive audio component may select the set of audio processing parameters associated with location zone 760. In another example, if (i) the user is within location zone 740 and location zone 750 and (ii) location zone 740 has a higher priority than location zone 750, then then the adaptive audio component may select the set of audio processing parameters associated with location zone 740.

In certain embodiments, the adaptive audio component 110 may prohibit the user from defining overlapping location zones. In such embodiments, the adaptive audio component 110 may include functionality (e.g., via the input controller, such as computing device 150) that restricts the user from setting a location zone size if the resulting location zone would overlap with an existing location zone.

In certain embodiments, the adaptive audio component may derive a set of audio processing parameters associated with a user location that is between two or more location zones, based on the respective set of audio processing parameter for one or more of the location zones. Using the scenario 700 depicted as a reference example, assume that the user is located between location zone 740 and location zone 750. In this example, the adaptive audio component may derive a set of audio processing parameters for the user's location, based on the set of audio processing parameters associated with location zone 740, the set of audio processing parameters associated with location zone 750, or a combination thereof. In certain embodiments, the derivation of the set of audio processing parameters may be based on an interpolation of the audio processing parameters from the nearest location zone(s). As a reference example, assuming the volume level setting for location zone 740 is 10%, the volume level setting for location zone 750 is 60%, and the user is located at a midpoint between a center of location zone 740 and a center of location zone 750, then the adaptive audio component may derive a volume level setting equal to approximately 35% for the user's location. That is, the adaptive audio component may determine an intermediate value for the volume level setting whose magnitude is proportional to the distance of the user between location zone 740 and location zone 750. Note, however, that is merely an example and that the adaptive audio component may derive other types of audio processing parameters using other estimation techniques, such as linear extrapolation, trilinear interpolation, and linear regression, as illustrative, non-limiting examples.

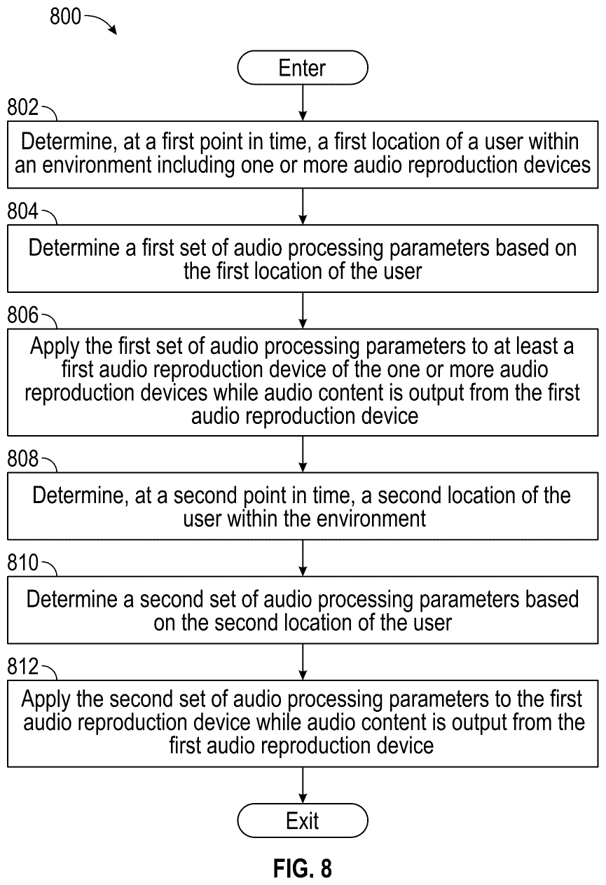

FIG. 8 is a flowchart of a method 800 for dynamically performing location-based audio processing for one or more audio reproduction devices (e.g., audio reproduction devices 104). The method 800 may be performed by an adaptive audio component (e.g., adaptive audio component 110) running on a computing device, such as audio reproduction device 104, computing system 140, or computing device 150. In certain embodiments, the method 800 may be performed continually over time, e.g., to dynamically adapt the audio processing for one or more audio reproduction devices as the user's location changes over time.

Method 800 may enter at block 802, where the adaptive audio component determines, at a first point in time, a first location of a user (e.g., user 108) within an environment that includes one or more audio reproduction devices (e.g., audio reproduction devices 104).

At block 804, the adaptive audio component determines a first set of audio processing parameters based on the first location of the user.

At block 806, the adaptive audio component applies the first set of audio processing parameters to at least a first audio reproduction device of the one or more audio reproduction devices while audio content (e.g., audio content 112) is output from the first audio reproduction device.

In certain embodiments, the determination of the first location of the user (at block 802) may include determining a location of a computing device (e.g., computing device 150) associated with the user within the environment, where the location of the computing device is indicative of the first location of the user.

In one embodiment, the location of the computing device may be determined based on one or more sensors (e.g., sensor(s) 260) of the computing device. In one embodiment, the location of the computing device may be determined based on an exchange of wireless communications with a wireless positioning system that operates according to a wireless communication protocol (e.g., BLE, UWB, WiFi, etc.). In one embodiment, the location of the computing device may be determined based on (i) one or more sensors of the computing device and (ii) the exchange of wireless communications with the wireless positioning system. In some cases, the location of the computing device may be a geographical location of the computing device and may include a geographical coordinate in a geographical coordinate system. In other cases, the location of the computing device may be relative to a location of another computing device within the environment.

In one embodiment, the computing device may include the first audio reproduction device (e.g., the first audio reproduction device may be a wearable device collocated with the user). In another embodiment, the computing device may include a second audio reproduction device of the one or more audio reproduction devices (e.g., the first audio reproduction device may be a loudspeaker and the second audio reproduction device may be a wearable device collocated with the user).

In certain embodiments, the first location of the user may be within a predefined location zone (e.g., location zone 640) within the environment, and the first set of audio processing parameters may be associated with the predefined location zone. At least one of an area or a contour of the predefined location zone may be user-defined (e.g., via an input controller).

In certain embodiments, the first location of the user may be outside a first predefined location zone (e.g., location zone 740), and the first set of audio processing parameters may be associated with locations external to the first predefined location zone. In such embodiments, the first location of the user may be between the first predefined location zone and another second predefined location zone (e.g., location zone 750) within the environment.

In certain embodiments, the first location of the user may be between the first predefined location zone and another second predefined location zone (e.g., location zone 750) within the environment. In such embodiments, the first set of audio processing parameters may be derived based on a set of audio processing parameters associated with the first predefined location zone, another set of audio processing parameters associated with the second predefined location zone, or a combination thereof.

In certain embodiments, the first location of the user may be within multiple predefined location zones within the environment (e.g., the user may be located within overlapping location zones). In such embodiments, the determination of the first set of audio processing parameters (at block 804) may include (i) determining at least one of a respective confidence level of the first location of the user being within each of the multiple predefined location zones or a respective priority of each of the multiple predefined location zones, (ii) determining, from the multiple predefined location zones, a first predefined location zone having at least one of a highest confidence level or a highest priority, and (iii) selecting, as the first set of audio processing parameters, a predefined set of audio processing parameters associated with the first predefined location zone.

In certain embodiments, the method 800 may further involve operations at block 808, 810, and 812. At block 808, the adaptive audio component determines, at a second point in time, a second location of the user within the environment, e.g., using any of the techniques described herein. The second point in time may be subsequent to the first point in time.

At block 810, the adaptive audio component determines a second set of audio processing parameters based on the second location of the user, e.g., using any of the techniques described herein. A value of at least one audio processing parameter of the first set of audio processing parameters may be different than a value of a corresponding audio processing parameter of the second set of audio processing parameters.

At block 812, the adaptive audio component applies the second set of audio processing parameters to the first audio reproduction device while audio content is output from the first audio reproduction device. In some cases, the first audio reproduction device may be a wearable device collocated with the user. In other cases, the first audio reproduction device may be a loudspeaker device deployed at a third location within the environment that is different from the first location of the user and the second location of the user.

In certain embodiments, the method 800 may further involve the adaptive audio component (i) applying the second set of audio processing parameters to a second audio reproduction device of the one or more audio reproduction devices when the user is at the second location, (ii) applying a third set of audio processing parameters to the first audio reproduction device when the user is at the second location, or (iii) any combination thereof. For example, the first audio reproduction device may be a first loudspeaker deployed at a third location within the environment different from the first location of the user and the second location of the user, and the second audio reproduction device may be a second loudspeaker deployed at a fourth location within the environment different from the first location of the user, the second location of the user, and the third location.

In certain embodiments, the determination of the first set of audio processing parameters (at block 804) may include selecting, as the first set of audio processing parameters, a predefined set of audio processing parameters associated with the first location of the user.

In certain embodiments, the determination of the first set of audio processing parameters (at block 804) may include (i) determining one or more metadata tags associated with the first location of the user; (ii) evaluating the one or more metadata tags with at least one of a machine learning model or a rules-based engine, (iii) generating a set of audio processing parameters, based on evaluating the one or more metadata tags with at least one of a machine learning model or a rules-based engine; and (iv) selecting, as the first set of audio processing parameters, the generated set of audio processing parameters.

In certain embodiments, the determination of the first set of audio processing parameters (at block 804) may include (i) determining one or more metadata tags associated with the first location of the user; (ii) generating and transmitting a request for the first set of audio processing parameters to a computing system, the request comprising the one or more metadata tags; and (iii) receiving, from the computing system, a response comprising the first set of audio processing parameters.

In certain embodiments, the method 800 may further involve the adaptive audio component (i) obtaining feedback from the user regarding the first set of audio processing parameters; (ii) modifying the first set of audio processing parameters based on feedback; and (iii) applying the modified set of audio processing parameters to the first audio reproduction device while audio content is output from the first audio reproduction device.

Advantageously, the techniques described herein allow for dynamically adjusting audio processing parameters based on a user's real-time location within an environment. In this manner, embodiments herein allow for automatically adapting (e.g., without human intervention with a computing device) audio being output from one or more audio reproduction devices, such that the auditory experience is modified in a way that is intuitive and expected by the user for the user's location.

### EXAMPLE CLAUSES

Implementation examples are described in the following numbered clauses:

Clause 1: A computer-implemented method comprising: determining, at a first point in time, a first location of a user within an environment comprising one or more audio reproduction devices; determining a first set of audio processing parameters based on the first location of the user; and applying the first set of audio processing parameters to at least a first audio reproduction device of the one or more audio reproduction devices while audio content is output from the first audio reproduction device.

Clause 2: The computer-implemented method of Clause 1, wherein determining the first location of the user comprises determining a location of a computing device associated with the user within the environment, the location of the computing device being indicative of the first location of the user.

Clause 3: The computer-implemented method of Clause 2, wherein the location of the computing device is determined based on one or more sensors of the computing device.

Clause 4: The computer-implemented method of any one of Clauses 2-3, wherein the location of the computing device is determined based on an exchange of wireless communications with a wireless positioning system that operates according to a wireless communication protocol.

Clause 5: The computer-implemented method of any one of Clauses 2-4, wherein the location of the computing device is a geographical location of the computing device and comprises a geographical coordinate in a geographical coordinate system.

Clause 6: The computer-implemented method of any one of Clauses 2-4, wherein the location of the computing device is relative to at least one of the location of the computing device or a location of another computing device within the environment.

Clause 7: The computer-implemented method of any one of Clauses 2-6, wherein the computing device comprises the first audio reproduction device.

Clause 8: The computer-implemented method of any one of Clauses 2-6, wherein the computing device comprises a second audio reproduction device of the one or more audio reproduction devices.

Clause 9: The computer-implemented method of any one of Clauses 1-8, wherein determining the first location of the user comprises obtaining location data indicative of the first location of the user.

Clause 10: The computer-implemented method of Clause 9, wherein the location data is obtained from one or more sensors within the environment.

Clause 11: The computer-implemented method of any one of Clauses 1-10, wherein: the first location of the user is within a predefined location zone within the environment; and the first set of audio processing parameters is associated with the predefined location zone.

Clause 12: The computer-implemented method of Clause 11, wherein at least one of an area or a contour of the predefined location zone is user-defined.

Clause 13: The computer-implemented method of any one of Clauses 1-10, wherein: the first location of the user is outside a first predefined location zone within the environment; and the first set of audio processing parameters is associated with locations external to the first predefined location zone.

Clause 14: The computer-implemented method of Clause 13, wherein the first location of the user is between the first predefined location zone and a second predefined location zone within the environment.

Clause 15: The computer-implemented method of Clause 14, wherein determining the first set of audio processing parameters comprises: deriving the first set of audio processing parameters based on a set of audio processing parameters associated with the first predefined location zone, a set of audio processing parameters associated with the second predefined location zone, or a combination thereof.

Clause 16: The computer-implemented method of any one of Clauses 1-12, wherein: the first location of the user is within a plurality of predefined location zones within the environment; and determining the first set of audio processing parameters comprises: determining at least one of (i) a respective confidence level of the first location of the user being within each of the plurality of predefined location zones or (ii) a respective priority of each of the plurality of predefined location zones; determining, from the plurality of predefined location zones, a first predefined location zone having at least one of (i) a highest confidence level or (ii) a highest priority; and selecting, as the first set of audio processing parameters, a predefined set of audio processing parameters associated with the first predefined location zone.

Clause 17: The computer-implemented method of any one of Clauses 1-16, further comprising: determining, at a second point in time subsequent to the first point in time, a second location of the user within the environment; determining a second set of audio processing parameters based on the second location of the user; and applying the second set of audio processing parameters to the first audio reproduction device.

Clause 18: The computer-implemented method of Clause 17, wherein a value of at least one audio processing parameter of the first set of audio processing parameters is different than a value of a corresponding audio processing parameter of the second set of audio processing parameters.

Clause 19: The computer-implemented method of any one of Clauses 17-18, wherein the first audio reproduction device is a wearable device collocated with the user.

Clause 20: The computer-implemented method of any one of Clauses 17-18, wherein the first audio reproduction device is a loudspeaker device deployed at a third location within the environment different from the first location of the user and the second location of the user.

Clause 21: The computer-implemented method of Clause 17, further comprising at least one of: applying the second set of audio processing parameters to a second audio reproduction device of the one or more audio reproduction devices when the user is at the second location; or applying a third set of audio processing parameters to the first audio reproduction device when the user is at the second location.

Clause 22: The computer-implemented method of Clause 21, wherein: the first audio reproduction device is a first loudspeaker deployed at a third location within the environment different from the first location of the user and the second location of the user; and the second audio reproduction device is a second loudspeaker deployed at a fourth location within the environment different from the first location of the user, the second location of the user, and the third location.

Clause 23: The computer-implemented method of any one of Clauses 1-22, wherein determining the first set of audio processing parameters comprises selecting, as the first set of audio processing parameters, a predefined set of audio processing parameters associated with the first location of the user.

Clause 24: The computer-implemented method of any one of Clauses 1-22, wherein determining the first set of audio processing parameters comprises: determining one or more metadata tags associated with the first location of the user; evaluating the one or more metadata tags with at least one of a machine learning model or a rules-based engine; generating a set of audio processing parameters, based on evaluating the one or more metadata tags with at least one of a machine learning model or a rules-based engine; and selecting, as the first set of audio processing parameters, the generated set of audio processing parameters.

Clause 25: The computer-implemented method of any one of Clauses 1-22, wherein determining the first set of audio processing parameters comprises: determining one or more metadata tags associated with the first location of the user; generating and transmitting a request for the first set of audio processing parameters to a computing system, the request comprising the one or more metadata tags; and receiving, from the computing system, a response comprising the first set of audio processing parameters.

Clause 26: The computer-implemented method of any one of Clauses 1-25, further comprising: obtaining feedback from the user regarding the first set of audio processing parameters; modifying the first set of audio processing parameters based on feedback; and applying the modified set of audio processing parameters to the first audio reproduction device while audio content is output from the first audio reproduction device.

Clause 27: An audio reproduction device, comprising: one or more speaker components; one or more memories collectively storing instructions; and one or more processors coupled to the one or more memories and to the one or more speaker components, the one or more processors being collectively configured to execute the instructions to cause the audio reproduction device to perform the method of any one of Clauses 1-26.

Clause 28: A computer readable medium comprising instructions that, when executed by one or more processors of a computing system, cause the computing system to perform the method of any one of Clauses 1-26.

Clause 29: An apparatus comprising means for performing the method of any one of Clauses 1-26.

Clause 30: A computing device, comprising: one or more memories collectively storing instructions; and one or more processors coupled to the one or more memories, the one or more processors being collectively configured to execute the instructions to cause the computing device to perform the method of any one of Clauses 1-26.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The descriptions of the various embodiments of the present approaches have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements described herein, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages described herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the presently taught approaches may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present presently taught approaches may be provided by way of a system, a method, and/or a computer program product. The computer program product may include a computer readable medium (or media) comprising computer readable program instructions for causing a processor to carry out aspects of the presently taught approaches.

The computer readable medium can be provided as a computer readable storage medium and/or a computer readable transmission medium. A computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable transmission medium may include any medium used for conveying instructions between components of a single computer system, and/or between plural separate computer systems. Such computer readable transmission media may include transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. As used herein, a computer readable storage medium (which may be described as being non-transitory) does not include any transitory signals per se.

Computer readable program instructions described herein can be downloaded to respective computing/processing devices from a computer readable storage medium or to an external computer or external storage device via a network, for example, the Internet, a local area network, a wide area network and/or a wireless network, all of which may employ a computer readable transmission medium. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the presently taught approaches may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network (which again may employ a computer readable transmission medium), including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), ML hardware accelerators, graphics processing units (GPUs), or programmable logic arrays (PLA) may execute the computer readable program instructions by utilizing state information of the computer readable program instructions to personalize the electronic circuitry, in order to perform aspects of the presently taught approaches.

Aspects of the presently taught approaches are described herein with reference to flowchart illustrations and/or block diagrams of methods, apparatus (systems), and computer program products according to embodiments of the presently taught approaches. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the presently taught approaches. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the presently taught approaches may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. Doing so allows a user to access this information from any computing system attached to a network connected to the cloud (e.g., the Internet).

Therefore, from one perspective, there have been described techniques, computing devices, and systems for location based audio processing are described. An example technique includes determining, at a point in time, a location of a user within an environment including one or more audio reproduction devices. A set of audio processing parameters is determined based on the location of the user. The set of audio processing parameters is applied to at least one audio reproduction device of the one or more audio reproduction devices while audio content is output from the at least one audio reproduction device.

Further examples are set out in the following numbered clauses.

Clause 1. A computer-implemented method comprising: determining, at a first point in time, a first location of a user within an environment comprising one or more audio reproduction devices; determining a first set of audio processing parameters based on the first location of the user; and applying the first set of audio processing parameters to at least a first audio reproduction device of the one or more audio reproduction devices while audio content is output from the first audio reproduction device.

Clause 2. The computer-implemented method of clause 1, wherein determining the first location of the user comprises determining a location of a computing device associated with the user within the environment, the location of the computing device being indicative of the first location of the user.

Clause 3. The computer-implemented method of clause 2, wherein the location of the computing device is determined based on one or more sensors of the computing device.

Clause 4. The computer-implemented method of clause 2 or 3, wherein the location of the computing device is determined based on an exchange of wireless communications with a wireless positioning system that operates according to a wireless communication protocol.

Clause 5. The computer-implemented method of clause 2, 3 or 4, wherein the location of the computing device is a geographical location of the computing device and comprises a geographical coordinate in a geographical coordinate system.

Clause 6. The computer-implemented method of any of clauses 2 to 5, wherein the location of the computing device is relative to at least one of the location of the computing device or a location of another computing device within the environment.

Clause 7. The computer-implemented method of any of clauses 2 to 6, wherein the computing device comprises the first audio reproduction device.

Clause 8. The computer-implemented method of any of clauses 2 to 7, wherein the computing device comprises a second audio reproduction device of the one or more audio reproduction devices.

Clause 9. The computer-implemented method of any preceding clause, wherein determining the first location of the user comprises obtaining location data indicative of the first location of the user.

Clause 10. The computer-implemented method of clause 9, wherein the location data is obtained from one or more sensors within the environment.

Clause 11. The computer-implemented method of any preceding clause, wherein: the first location of the user is within a predefined location zone within the environment; and the first set of audio processing parameters is associated with the predefined location zone.

Clause 12. The computer-implemented method of clause 11, wherein at least one of an area or a contour of the predefined location zone is user-defined.

Clause 13. The computer-implemented method of any preceding clause, wherein: the first location of the user is outside a first predefined location zone within the environment; and the first set of audio processing parameters is associated with locations external to the first predefined location zone.

Clause 14. The computer-implemented method of clause 13, wherein the first location of the user is between the first predefined location zone and a second predefined location zone within the environment.

Clause 15. The computer-implemented method of clause 14, wherein determining the first set of audio processing parameters comprises deriving the first set of audio processing parameters based on a set of audio processing parameters associated with the first predefined location zone, a set of audio processing parameters associated with the second predefined location zone, or a combination thereof.

Clause 16. The computer-implemented method of any preceding claim, wherein: the first location of the user is within a plurality of predefined location zones within the environment; and determining the first set of audio processing parameters comprises: determining at least one of (i) a respective confidence level of the first location of the user being within each of the plurality of predefined location zones or (ii) a respective priority of each of the plurality of predefined location zones; determining, from the plurality of predefined location zones, a first predefined location zone having at least one of (i) a highest confidence level or (ii) a highest priority; and selecting, as the first set of audio processing parameters, a predefined set of audio processing parameters associated with the first predefined location zone.

Clause 17. The computer-implemented method of any preceding clause, further comprising: determining, at a second point in time subsequent to the first point in time, a second location of the user within the environment; determining a second set of audio processing parameters based on the second location of the user; and applying the second set of audio processing parameters to the first audio reproduction device.

Clause 18. The computer-implemented method of clause 17, wherein a value of at least one audio processing parameter of the first set of audio processing parameters is different than a value of a corresponding audio processing parameter of the second set of audio processing parameters.

Clause 19. The computer-implemented method of clause 17 or 18, wherein the first audio reproduction device is a wearable device collocated with the user.

Clause 20. The computer-implemented method of clause 17, 18 or 19, wherein the first audio reproduction device is a loudspeaker device deployed at a third location within the environment different from the first location of the user and the second location of the user.

Clause 21. The computer-implemented method of any of clauses 17 to 20, further comprising at least one of: applying the second set of audio processing parameters to a second audio reproduction device of the one or more audio reproduction devices when the user is at the second location; or applying a third set of audio processing parameters to the first audio reproduction device when the user is at the second location.

Clause 22. The computer-implemented method of clause 21, wherein: the first audio reproduction device is a first loudspeaker deployed at a third location within the environment different from the first location of the user and the second location of the user; and the second audio reproduction device is a second loudspeaker deployed at a fourth location within the environment different from the first location of the user, the second location of the user, and the third location.

Clause 23. The computer-implemented method of any preceding clause, wherein determining the first set of audio processing parameters comprises selecting, as the first set of audio processing parameters, a predefined set of audio processing parameters associated with the first location of the user.

Clause 24. The computer-implemented method of any preceding clause, wherein determining the first set of audio processing parameters comprises: determining one or more metadata tags associated with the first location of the user; evaluating the one or more metadata tags with at least one of a machine learning model or a rules-based engine; generating a set of audio processing parameters, based on evaluating the one or more metadata tags with at least one of a machine learning model or a rules-based engine; and selecting, as the first set of audio processing parameters, the generated set of audio processing parameters.

Clause 25. The computer-implemented method of any preceding clause, wherein determining the first set of audio processing parameters comprises: determining one or more metadata tags associated with the first location of the user; generating and transmitting a request for the first set of audio processing parameters to a computing system, the request comprising the one or more metadata tags; and receiving, from the computing system, a response comprising the first set of audio processing parameters.

Clause 26. The computer-implemented method of any preceding clause, further comprising: obtaining feedback from the user regarding the first set of audio processing parameters; modifying the first set of audio processing parameters based on feedback; and applying the modified set of audio processing parameters to the first audio reproduction device while audio content is output from the first audio reproduction device.

Clause 27. An audio reproduction device, comprising: one or more speaker components; one or more memories collectively storing instructions; and one or more processors coupled to the one or more memories and to the one or more speaker components, the one or more processors being collectively configured to execute the instructions to cause the audio reproduction device to perform an operation comprising: determining, at a point in time, a location of a user within an environment comprising the audio reproduction device; determining a set of audio processing parameters based on the location of the user; and applying the set of audio processing parameters while outputting audio content from the one or more speaker components.

While the foregoing is directed to embodiments of the presently taught approaches, other and further embodiments of the presently taught approaches may be devised without departing from the basic scope thereof, and the scope thereof is determined by the claims that follow.

What is claimed is:

1. A computer-implemented method comprising:
determining, at a first point in time, a first location of a user within an environment comprising one or more audio reproduction devices;
determining a first set of audio processing parameters based on the first location of the user; and
applying the first set of audio processing parameters to at least a first audio reproduction device of the one or more audio reproduction devices while audio content is output from the first audio reproduction device.

2. The computer-implemented method of claim 1, wherein determining the first location of the user comprises determining a location of a computing device associated with the user within the environment, the location of the computing device being indicative of the first location of the user.

3. The computer-implemented method of claim 2, wherein the location of the computing device is determined based on one or more sensors of the computing device.

4. The computer-implemented method of claim 2, wherein the location of the computing device is determined based on an exchange of wireless communications with a wireless positioning system that operates according to a wireless communication protocol.

5. The computer-implemented method of claim 2, wherein the location of the computing device is a geographical location of the computing device and comprises a geographical coordinate in a geographical coordinate system.

6. The computer-implemented method of claim 2, wherein the location of the computing device is relative to at least one of the location of the computing device or a location of another computing device within the environment.

7. The computer-implemented method of claim 2, wherein the computing device comprises the first audio reproduction device.

8. The computer-implemented method of claim 2, wherein the computing device comprises a second audio reproduction device of the one or more audio reproduction devices.

9. The computer-implemented method of claim 1, wherein determining the first location of the user comprises obtaining location data indicative of the first location of the user.

10. The computer-implemented method of claim 9, wherein the location data is obtained from one or more sensors within the environment.

11. The computer-implemented method of claim 1, wherein:
the first location of the user is within a predefined location zone within the environment; and
the first set of audio processing parameters is associated with the predefined location zone.

12. The computer-implemented method of claim 11, wherein at least one of an area or a contour of the predefined location zone is user-defined.

13. The computer-implemented method of claim 1, wherein:
the first location of the user is outside a first predefined location zone within the environment; and
the first set of audio processing parameters is associated with locations external to the first predefined location zone.

14. The computer-implemented method of claim 13, wherein the first location of the user is between the first predefined location zone and a second predefined location zone within the environment.

15. The computer-implemented method of claim 14, wherein determining the first set of audio processing parameters comprises deriving the first set of audio processing parameters based on a set of audio processing parameters associated with the first predefined location zone, a set of audio processing parameters associated with the second predefined location zone, or a combination thereof.

16. The computer-implemented method of claim 1, wherein:
the first location of the user is within a plurality of predefined location zones within the environment; and
determining the first set of audio processing parameters comprises:
determining at least one of (i) a respective confidence level of the first location of the user being within each of the plurality of predefined location zones or (ii) a respective priority of each of the plurality of predefined location zones;
determining, from the plurality of predefined location zones, a first predefined location zone having at least one of (i) a highest confidence level or (ii) a highest priority; and
selecting, as the first set of audio processing parameters, a predefined set of audio processing parameters associated with the first predefined location zone.

17. The computer-implemented method of claim 1, further comprising:
determining, at a second point in time subsequent to the first point in time, a second location of the user within the environment;
determining a second set of audio processing parameters based on the second location of the user; and
applying the second set of audio processing parameters to the first audio reproduction device.

18. The computer-implemented method of claim 17, wherein a value of at least one audio processing parameter of the first set of audio processing parameters is different than a value of a corresponding audio processing parameter of the second set of audio processing parameters.

19. The computer-implemented method of claim 17, wherein the first audio reproduction device is a wearable device collocated with the user.

20. The computer-implemented method of claim 17, wherein the first audio reproduction device is a loudspeaker device deployed at a third location within the environment different from the first location of the user and the second location of the user.

21. The computer-implemented method of claim 17, further comprising at least one of:
applying the second set of audio processing parameters to a second audio reproduction device of the one or more audio reproduction devices when the user is at the second location; or
applying a third set of audio processing parameters to the first audio reproduction device when the user is at the second location.

22. The computer-implemented method of claim 21, wherein:
the first audio reproduction device is a first loudspeaker deployed at a third location within the environment different from the first location of the user and the second location of the user; and
the second audio reproduction device is a second loudspeaker deployed at a fourth location within the environment different from the first location of the user, the second location of the user, and the third location.

23. The computer-implemented method of claim 1, wherein determining the first set of audio processing parameters comprises selecting, as the first set of audio processing parameters, a predefined set of audio processing parameters associated with the first location of the user.

24. The computer-implemented method of claim 1, wherein determining the first set of audio processing parameters comprises:
determining one or more metadata tags associated with the first location of the user;
evaluating the one or more metadata tags with at least one of a machine learning model or a rules-based engine;
generating a set of audio processing parameters, based on evaluating the one or more metadata tags with at least one of a machine learning model or a rules-based engine; and
selecting, as the first set of audio processing parameters, the generated set of audio processing parameters.

25. The computer-implemented method of claim 1, wherein determining the first set of audio processing parameters comprises:
determining one or more metadata tags associated with the first location of the user;
generating and transmitting a request for the first set of audio processing parameters to a computing system, the request comprising the one or more metadata tags; and
receiving, from the computing system, a response comprising the first set of audio processing parameters.

26. The computer-implemented method of claim 1, further comprising:
obtaining feedback from the user regarding the first set of audio processing parameters;
modifying the first set of audio processing parameters based on feedback; and
applying the modified set of audio processing parameters to the first audio reproduction device while audio content is output from the first audio reproduction device.

27. An audio reproduction device, comprising:
one or more speaker components;
one or more memories collectively storing instructions; and
one or more processors coupled to the one or more memories and to the one or more speaker components, the one or more processors being collectively configured to execute the instructions to cause the audio reproduction device to perform an operation comprising:
determining, at a point in time, a location of a user within an environment comprising the audio reproduction device;
determining a set of audio processing parameters based on the location of the user; and
applying the set of audio processing parameters while outputting audio content from the one or more speaker components.
